(19) United States
(12) Patent Application Publication
(10) Pub. No.: US 2023/0329206 A1
(43) Pub. Date: Oct. 19, 2023

(54) ANTI-BACKLASH BAIT CAST FISHING REEL

(71) Applicant: Pure Fishing, Inc., Spirit Lake, IA (US)

(72) Inventors: Benjamin Philip Parker, Chardon, OH (US); William Sebastian, Northfield, OH (US); William Eugene Rabbitt, Chesterland, OH (US); Robert F. Soreo, Cleveland Heights, OH (US)

(21) Appl. No.: 18/339,304

(22) Filed: Jun. 22, 2023

Related U.S. Application Data
(63) Continuation of application No. PCT/US2021/063053, filed on Dec. 13, 2021.
(60) Provisional application No. 63/128,895, filed on Dec. 22, 2020.

(51) Int. Cl. A01K 89/0155; A01K 97/12

(52) U.S. Cl. CPC A01K 89/0155; A01K 97/125

(57) ABSTRACT

A fishing reel includes a frame, a spool coupled to the frame for rotation about a rotational axis, a light source, a first optic, a sensor, a second optic, a controller, and a braking mechanism. The spool includes a first flange and a second flange. The first optic is positioned such that light emanating from the light source and passing through the first optic generates a substantially collimated band of light parallel with the rotational axis. The second optic is positioned and configured to focus the substantially collimated band of light toward the sensor. The controller is electrically coupled to the sensor and is configured to receive signals from the sensor and to generate a braking signal. The braking mechanism is electrically coupled to the controller, and the braking mechanism applies a braking force to slow the spool in response to the braking signal.

### CROSS REFERENCE TO RELATED APPLICATIONS

This application is a continuation application of PCT application no. PCT/US2021/063053 filed on Dec. 13, 2021, which claims the benefit of priority from U.S. provisional patent application 63/128,895 filed on Dec. 22, 2020. The disclosures of PCT/US2021/063053 and 63/128,895 are incorporated herein by reference.

### BACKGROUND

A bait cast fishing reel has a shortcoming referred to as backlash, which occurs when the reel spool overruns the outgoing line, causing the outgoing line to be caught and pulled back under the rotating spool, resulting in a knotted tangle of line commonly referred to as a “bird's nest.”

Several patents have disclosures attempting to solve the problem of backlash, one of which being U.S. Pat. No. 7,784,724 B2, which is directed to a non-contact line sensor that captures image data of a backlash condition of fishing line as the fishing line travels through a backlash zone over time. Considering the components listed in this patent, a control loop result for determining a backlash condition is around 100 milliseconds. Similarly, U.S. Pat. No. 8,439,290 B2 employs a line behavior sensor having means for digital imaging where the sensor generates output signals derived from recorded images of fishing line as the line is paying out. In U.S. Pat. No. 8,439,290 B2, a computer is associated with the sensor and compares the output signals to control a brake mechanism. U.S. Pat. No. 6,045,076 B1 discloses a photo emitter that emits a light beam and a portion of the emitted light beam hits a bundle of line wrapped tightly around a spool where it is totally reflected back to a photo detector. In U.S. Pat. No. 6,045,076 B1, a portion of the light beam that does not reflect from the bundle of tightly wrapped line is transmitted and absorbed by an infrared absorbing material on an opposite side of the spool so as not to influence the detection of reflected light.

In view of the foregoing, fishing reels that employ mechanisms to determine a backlash condition can be improved to more quickly determine the backlash condition and reducing the size of the mechanism for determining the backlash condition.

### SUMMARY

In view of the foregoing, a fishing reel includes a frame, a spool coupled to the frame for rotation about a rotational axis, a light source, a first optic, a sensor, a second optic, a controller, and a braking mechanism. The spool includes a first flange at or adjacent one end of the spool and a second flange at or adjacent an opposite end of the spool. The first optic is positioned in relation to the light source and the spool such that light emanating from the light source and passing through the first optic generates a substantially collimated band of light parallel with the rotational axis. The second optic is positioned in relation to the light source, the spool, and the sensor, and is configured to focus the substantially collimated band of light toward the sensor. The controller is electrically coupled to the sensor and is configured to receive signals from the sensor and to generate a braking signal based on received signals from the sensor. The braking mechanism is electrically coupled to the controller, and the braking mechanism applies a braking force to slow the spool in response to the braking signal from the controller.

For the fishing reel described above, each of the first flange and the second flange can include at least one respective flange opening extending therethrough, and the substantially collimated band of light passes through the respective flange openings. More particularly, each of the first flange and the second flange can include a plurality of respective flange openings extending therethrough.

For either the fishing reel described in the aforementioned paragraph or the one above it, the light source can be a light emitting diode (LED). More particularly, the light source can be a single LED.

For any of the fishing reels described in the aforementioned paragraphs, the first optic or the second optic can be a Fresnel lens of an aspheric lens.

For any of the fishing reels described in the aforementioned paragraphs, the first optic can be positioned in relation to the light source such that the substantially collimated band of light extends outwardly in a direction perpendicular to the rotational axis outside of an outer diameter of the first flange and/or the second flange.

For any of the fishing reels described in the aforementioned paragraphs, the second optic can be identical in configuration to the first optic and rotated 180 degrees from the orientation of the first optic about an axis perpendicular to the rotational axis.

For any of the fishing reels described in the aforementioned paragraphs, the sensor can be a PIN diode that converts optical signals into electrical signals.

For any of the fishing reels described in the aforementioned paragraphs, the controller can be a low-power 8 or 32 bit microcontroller.

For any of the fishing reels described in the aforementioned paragraphs, the sensor can work with the controller to detect a difference in gain.

For any of the fishing reels described in the aforementioned paragraphs, the controller can be configured to generate and deliver the braking signal to the braking mechanism upon detecting a non-linear drop in gain.

For any of the fishing reels described in the aforementioned paragraphs, it can include a regenerative power source.

### BRIEF DESCRIPTION OF THE DRAWINGS

FIG. 1 is a schematic depiction of relevant components of a fishing reel.

FIG. 2 is a perspective view of a spool and a spool shaft for the fishing reel depicted in FIG. 1

### DETAILED DESCRIPTION

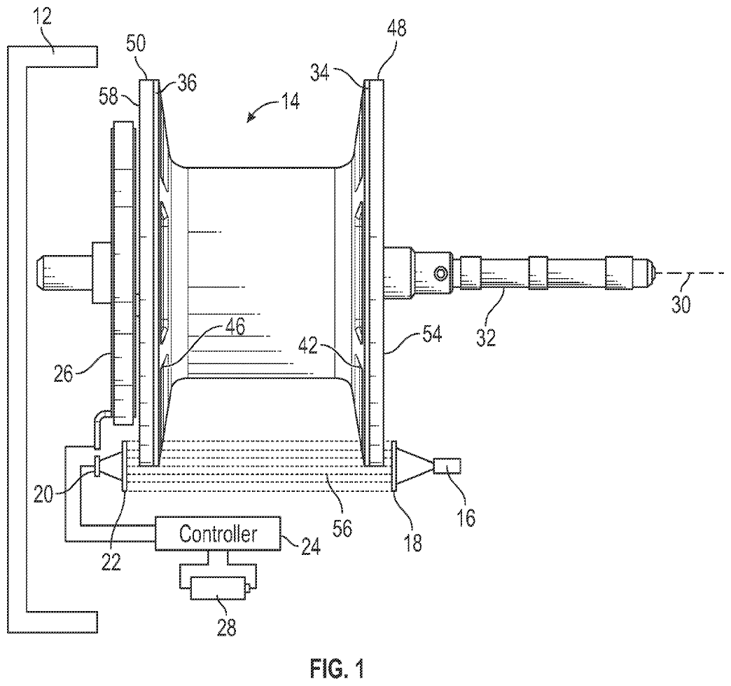

FIG. 1 depicts an example of components of a fishing reel 10 including a frame 12, a spool 14, a light source 16, a first optic 18, a sensor 20, a second optic 22, a controller 24, and a braking mechanism 26. The fishing reel 10 can further include a power source 28 for powering the light source 16, the sensor 20, the controller 24, and the braking mechanism 26. The power source can be a battery, for example, or a regenerative power source that is operatively connected to a spool drive (only a portion of which shown). The spool drive can be conventionally known and operatively with the spool 14, a line guide (also not shown), and a crank handle (not shown). The spool drive typically includes at least one gear train and upon being driven by the crank handle, the spool drive rotates the spool 14 and reciprocates the line guide in a conventionally known manner to retrieve fishing line wound around the spool 14. The spool drive can also include a clutch (also not shown) that is conventionally known and is operatively coupled between the spool 14 and the spool drive along with a drag mechanism. When the clutch is engaged, the spool drive and the drag are operatively coupled to the spool 14. As a result, rotation of the crank handle rotates the spool 14 to retrieve fishing line. At the same time, the drag mechanism slows reverse rotation of the spool 14 to release the fishing line. When the clutch is disengaged, to uncouple the spool 14 from the spool drive and the drag mechanism, the spool 14 is substantially free to rotate in a reverse direction to release fishing line such as during casting. During casting, unless appropriately braked, the spool 14 may rotate at a velocity faster than the velocity of the bait or lure and line being cast, which can result in backlash.

Only a portion of the frame 12 is depicted in FIG. 1. The frame 12 supports the spool 14, the light source 16, the first optic 18, the sensor 20, the second optic 22, the controller 24, and the braking mechanism 26 along with other components of the fishing reel 10. The frame 12 can additionally house the aforementioned components along with the spool drive, and the drag mechanism. The frame 12 can be made from various materials and come in a variety of different shapes and sizes.

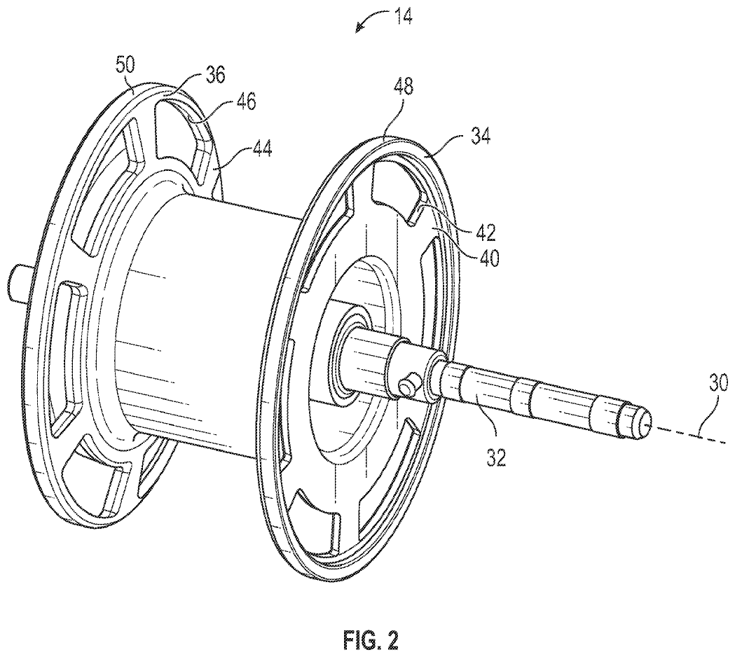

The spool 14 is coupled to the frame 12 for rotation about a rotational axis 30. The spool 14 mounts to a spool shaft 32 and includes a first flange 34 at or adjacent one end of the spool 14 and a second flange 36 at or adjacent an opposite end of the spool 14. The spool 14 is also operatively coupled to the spool drive and the drag mechanism. The spool 14 carries fishing line (not shown), which is wrapped around the spool 14 in between the first flange 34 and the second flange 36. In the illustrated embodiment and with reference to FIG. 2, the first flange 34 includes first flange spokes 40 separating and partially bounding first flange openings 42 extending through the first flange 34. Similarly, the second flange 36 includes second flange spokes 44 separating and partially bounding second flange openings 46 extending through the second flange 36. Each of the first flange 34 and the second flange 36 are shown as including six respective flange openings 42, 46; however, a fewer or greater number can be provided in each of the flanges 34, 36. Each of the flange openings 42, 46 is offset inwardly from a respective outer diameter 48, 50 of each flange 34, 36.

With reference back to FIG. 1, the light source 16 is positioned outwardly offset in a direction parallel to the rotational axis 30 from an outer side 54 of the first flange 34. The outer side 54 being the side of the first flange 34 opposite the side that is facing the fishing line wrapped around the spool 14. The light source 16 can be a light emitting diode (LED). More particularly, the light source 16 can be a single LED, which can facilitate miniaturization of the anti-backlash system.

The first optic 18 is positioned in relation to the light source 16 and the spool 14 such that light emanating from the light source 16 and passing through the first optic 18 generates a substantially collimated band of light 56 parallel with the rotational axis 30 of the spool 14. Examples of such an optic that can be used for the first optic 18 include a lens similar to a Fresnel lens as well as an aspheric lens. The light source 16 and the first optic 18 are cooperatively designed such that the substantially collimated band of light 56 passes through the flange openings 42, 46 in the respective flanges 34, 36. The light source 16 and the first optic 18 can also be cooperatively designed such that the substantially collimated band of light travels parallel with the rotational axis 30 radially outside with respect to a direction perpendicular to the rotational axis 30 of the respective outer diameter 48, 50 of each of the first flange 34 and the second flange 36. The first optic 18 is also positioned outwardly offset in a direction parallel with the rotational axis 30 from the outer side 54 of the first flange 34 and is interposed between the light source 16 and the first flange 34.

The sensor 20 is positioned outwardly offset in a direction parallel with the rotational axis 30 from an outer side 58 of the second flange 36. The sensor 20 can be a photo diode. More particularly, the sensor 20 can be a PIN diode that converts optical signals into electrical signals. The sensor 20 works with the controller 24 to detect a difference in gain (light received), which can be indicative of a loop of fishing line coming off the spool 14 just prior to a backlash condition. The gain typically increases as fishing line comes off the spool 14 during a cast because the diameter of the wound fishing line gradually decreases as the fishing line is paying out allowing more light from the substantially collimated band of light 56 to reach the sensor 20. This will result in a linear drop in gain as the cast progresses. The controller 24 can be configured to detect a non-linear drop in gain, which can be indicative of a loop condition. Upon detecting a non-linear drop in gain, the controller 24 generates and delivers a braking signal to the braking mechanism 26. Other types of light sensors than PIN diode can also be employed; however the use of a PIN diode can facilitate miniaturization of the anti-backlash system.

The second optic 22 is positioned in relation to the light source 16, the spool 14, and the sensor 20 and is configured to focus the substantially collimated band of light 56 toward the sensor 20. The second optic 22 is also positioned outwardly offset in a direction parallel with the rotational axis 30 from the outer side 58 of the second flange 36. The second optic 22 is positioned between the sensor 20 and the outer side 58 of the second flange 36. The second optic 22 can be identical in configuration to the first optic 18, but the orientation of the second optic 22 is different than the first optic 18 in that the second optic 22 is rotated 180 degrees from the orientation of the first optic 18 about an axis perpendicular to the rotational axis 30. Such an orientation allows the second optic 22 to focus the collimated band of light 56 toward the sensor 20, which can allow for miniaturization of the anti-backlash system.

The controller 24 is coupled to the sensor 20 and is configured to receive signals from the sensor 20 and to generate a braking signal based on the received signals from the sensor 20. The controller 24 can be, for example, a low-power 8 or 32 bit microcontroller. The braking mechanism 26, which can be a conventional braking mechanism such as the braking mechanism described in U.S. Pat. No. 7,784,724 B2 or the braking mechanism described in U.S. Pat. No. 6,412,722 B1, is coupled to the controller 24. The braking mechanism 26 applies a braking force to slow the spool 14 in response to the braking signal received from the controller 24.

The first optic 18 working in conjunction with the light source 16 results in the ability for a single LED, if desired, to spread the light evenly over a generally small rectangular area, such as a 10 mm×2 mm area. This substantially collimated band of light 56 can be received by the second optic 22 that focuses the collimated band of light 56 back down to a small diameter that is received by the sensor 20, which can be a single photo diode. Providing the substantially collimated band of light 56 allows the sensor 20 to “see” a line loop anywhere within the rectangular area. As an example, if the spool 14 is full of line and a long cast is made, the diameter of the line on the spool 14 decreases as the line comes off. With a long cast, this can amount to a significant diameter change. If the first optic 18 generated a round beam of light, the sensor 20 would only be able to detect a gain change over a small area as the diameter changes during the cast, and the round beam would need to keep getting larger for the sensor 20 to detect possible line loops. With a monofilament line, this is a greater issue because line memory prevents large loops from forming. The generally rectangular beam depicted as the substantially collimated band of light 56 allows the use of one LED and one photo detector, which can miniaturize the anti-backlash detection system. Even if a small loop of line begins to generate on the spool, it can be detected regardless of how much line remains on the spool 14 during the cast. This provides an anti-backlash system with significantly more resolution than simply using a round beam photo detector and a highly divergent output from an LED. By using the components and arrangements discussed above, the control loop result to determine a backlash condition is around 50 microseconds, which is much quicker than the prior art designs.

It will be appreciated that various features of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fishing reel comprising:
a frame;
a spool coupled to the frame for rotation about a rotational axis and including a first flange at or adjacent one end to the spool and a second flange at or adjacent an opposite end of the spool;
a light source;
a first optic positioned in relation to the light source and the spool such that light emanating from the light source and passing through the first optic generates a substantially collimated band of light parallel with the rotational axis;
a sensor;
a second optic positioned in relation to the light source, the spool and the sensor and configured to focus the substantially collimated band of light toward the sensor;
a controller electrically coupled to the sensor and configured to receive signals from the sensor and to generate a braking signal based on received signals from the sensor; and
a braking mechanism electrically coupled to the controller, wherein the braking mechanism applies a braking force to slow the spool in response to the braking signal from the controller.

2. The fishing reel of claim 1, wherein each of the first flange and the second flange include at least one respective flange opening extending therethrough, and the substantially collimated band of light passes through the respective flange openings.

3. The fishing reel of claim 2, wherein each of the first flange and the second flange include a plurality of respective flange openings extending therethrough.

4. The fishing reel of claim 1, wherein the light source is a light emitting diode (LED).

5. The fishing reel of claim 4, wherein the light source is a single LED.

6. The fishing reel of claim 1, wherein the first optic or the second optic is Fresnel lens or an aspheric lens.

7. The fishing reel of claim 1, wherein the first optic is positioned in relation to the light source such that the substantially collimated band of light extends outwardly in a direction perpendicular to the rotational axis outside of an outer diameter of the first flange.

8. The fishing reel of claim 1, wherein the first optic is positioned in relation to the light source such that the substantially collimated band of light extends outwardly in a direction perpendicular to the rotational axis outside of a respective outer diameter of each of the first flange and the second flange.

9. The fishing reel of claim 1, wherein the second optic is identical in configuration to the first optic and is rotated 180 degrees from the orientation of the first optic about an axis perpendicular to the rotational axis.

10. The fishing reel of claim 1, wherein the sensor is a PIN diode that converts optical signals into electrical signals.

11. The fishing reel of claim 1, wherein the controller is a low-power 8 or 32 bit microcontroller.

12. The fishing reel of claim 1, wherein the sensor works with the controller to detect a difference in gain.

13. The fishing reel of claim 1, wherein the controller is configured to generate and deliver the braking signal to the braking mechanism upon detecting a non-linear drop in gain.

14. The fishing reel of claim 1, further comprising a regenerative power source.

15. A fishing reel comprising:
a frame;
a spool coupled to the frame for rotation about a rotational axis and including a first flange at or adjacent one end to the spool and a second flange at or adjacent an opposite end of the spool, each of the first flange and the second flange including a plurality of respective flange openings extending therethrough;
a single light emitting diode (LED) positioned outwardly offset in a direction parallel to the rotational axis from an outer side of the first flange;
a first optic, which is a Fresnel lens or an aspheric lens, positioned between the single LED and the spool such that light emanating from the single LED and passing through the first optic generates a substantially collimated band of light parallel with the rotational axis, the substantially collimated band of light parallel through the respective flange openings and outwardly in a direction perpendicular to the rotational axis outside of a respective outer diameter of each of the first flange and the second flange;
a PIN diode positioned outwardly offset in a direction parallel to the rotational axis from an outer side of the second flange;
a second optic, which is a Fresnel lens or an aspheric lens, positioned in relation to the single LED and between the spool and the PIN diode, the second optic being configured to focus the substantially collimated band of light toward the PIN diode;
a controller electrically coupled to the PIN diode and configured to receive signals from the PIN diode and to generate a braking signal based on detecting a nonlinear drop in gain with the PIN diode; and
a braking mechanism electrically coupled to the controller, wherein the braking mechanism applies a braking force to slow the spool in response to the braking signal from the controller.
